(19) United States
(12) Patent Application Publication
(10) Pub. No.: US 2018/0095563 A1
(43) Pub. Date: Apr. 5, 2018

(54) NON-RECTILINEAR TOUCH SURFACE

(71) Applicant: Visteon Global Technologies, Inc., Van Buren Township, MI (US)

(72) Inventors: Akhil Keshav Mali, Pune (IN); Joy Marie Apostol, Romulus, MI (US); Douglas Allen Pfau, Canton, MI (US); Kathleen Ann Walsh, Farmington Hills, MI (US)

(21) Appl. No.: 15/286,206

(22) Filed: Oct. 5, 2016

(51) Int. Cl. G06F 3/047

(52) U.S. Cl. CPC G06F 3/047

(57) ABSTRACT

A non-rectilinear touch surface is disclosed herein. The non-rectilinear touch surface is shown with wires extending from a top to bottom side, and a left to right side, with the intersection of said wires allowing for the performance of touch-based technology. Also included herein is a method for producing the non-rectilinear touch surface.

### BACKGROUND

Electronic systems employ interfaces to interact with various systems and environments. These interfaces range from a variety of contact and contactless techniques, such as keyboards, buttons, pointer devices, and the like. In recent time, these interfaces may even employ cameras capable of detecting an image or video associated with a user's action.

One such newer technology being employed is related to translating touch into a command. Touch surfaces may be provided as a stand-alone surface (i.e. a touch pad), or as a display technology (i.e. a touch screen).

FIG. 1 illustrates an example implementation of a touch surface 100 of the prior art. As shown in FIG. 1, the x-axis 110 and the y-axis 120 each feed a plurality of lines to make up the matrix of the touch surface 100.

The y-axis 120 may be employed to instigate/scan signals through the touch surface 100, while the x-axis may be employed to sense signals generated from the y-axis. These roles may be reversed based on an implementer of the touch surface 100's preference.

As shown, scanning elements 125 instigate pulses through each of the y-axis 120 lines, and as a person touches a cell corresponding to one of the cells in the touch surface 100 (i.e. where each x-axis 110 line and y-axis 120 line meets), the sensors 115 detect the introduction of a signal generated (from the y-axis 120), a touch, and the respective sensor associated with both. As such, an electronic system associated with the touch surface 100 may be able to effectively detect a touch and a coordinate of said touch.

As would be expected, an overwhelming majority of touch surface 100 implementations have been rectilinear. However, there has been a need for non-rectilinear implementations. As touch surfaces become introduced to a variety of environments, non-rectilinear surfaces become more commonplace.

A handful of solutions have been proposed; however, these solutions have been fraught with additional processing costs and complexities. As shown in FIG. 2, a touch surface 200 of the prior art is shown. In FIG. 3, a system level diagram 300 for implementing touch surface 200 according to the prior art solution is shown.

As shown in FIG. 2, the touch surface 200 is substantially similar to the touch surface 100, except extra x-axis 110 lines (210) are provided to compensate for the non-rectilinear shape. As such, a non-rectilinear touch surface may be provided to the user interacting with an electronic system. The resultant pattern in touch surface 200 leads to an uneven number of touch cells per row (as a touch cell is defined as intersection between a x-axis line and a y-axis line).

As shown in FIG. 3, a system 300 is provided. As shown in FIG. 3, a detected touch data 301 is generated by the touch surface 200 of FIG. 2. This detection data 301 is then propagated to a step of converting said detected touch data 301 into a rectilinear data 311. This processing step may be done with a processor 310 (either stand-alone or integrated with a processor employed for other tasks).

As such, the converted data 311 (which is converted from the detected touch data 301) may be then used to interact with a rectilinear display 320. As shown in FIG. 3, most displays are rectilinear. And thus, because a non-rectilinear touch surface 200 is used, the data must necessarily be converted before interaction with the rectilinear display. Thus, employing a non-rectilinear touch surface 200 requires an extra processing step. In the field of communicating and interacting with displays (such as display 320), an extra step may cause delays, and frustrate the human machine interaction experience.

### SUMMARY

The following description relates to a non-rectilinear touch surface, as well as a method for providing a non-rectilinear touch surface.

A touch surface device is described herein. The touch surface includes a plurality of x-axis wires that extend from a left side to a right side, the right side opposing the left side; a plurality of y-axis wires that extend from a top side to a bottom side, the bottom side opposing the top side, the plurality of y-axis wires and the plurality of x-axis wires being overlaid with each other. Further, each of the plurality of x-axis wires are coupled to one of a plurality of signal generating elements or one of a plurality of sensing elements, and each of the plurality of y-axis wires are coupled to an opposite one of the plurality of signal generating elements or one of the plurality of sensing elements, and each of the plurality of y-axis wires form a respective angle from a side that extend from the top to bottom side and a horizontal plane, and includes a middle wire that has a respective angle of 90 degrees, and each of plurality of the y-axis wires to a right of the middle wire's respective angle is greater than 90 degrees, and vary in an increasing amount, and each of the plurality of the y-axis wires to a left of the middle wire's respective angle less than 90 degrees, and vary in a decreasing amount.

In another embodiment, the touch surface includes an orientation where each of the plurality of x-axis wires and the plurality of y-axis wires include a plurality of diamond shaped projections.

In another embodiment, each of the plurality of diamond shaped projections are sized so a plurality of gaps that form in response to the plurality of x-axis wires and y-axis wires being overlaid with each are consistent in size.

In another embodiment, the touch surface further comprises partial diamond shape projects on ends of each of the plurality of x-axis wires.

In another embodiment, each of the plurality of respective angles are chosen so that the number of intersections points between the plurality of x-axis wires and y-axis wires are the same per row.

A method for providing a non-rectilinear touch surface is described herein. The method includes providing a plurality of x-axis wires and y-axis wires overlaid with each other, each of the plurality of x-axis wires are coupled to one of a plurality of signal generating elements or one of a plurality of sensing elements, and each of the plurality of y-axis wires are coupled to an opposite one of the plurality of signal generating elements or one of the plurality of sensing element; orienting the y-axis wires are extended from a top to bottom side of the non-rectilinear touch surface so as to form a trapezoidal shape; providing a plurality of diamond projections on each of the plurality of x-axis wires and y-axis wires, so that in response to the plurality of x-axis wires and the plurality of y-axis wires being overlaid with each other, a constant gap between the plurality of diamond projections is maintained for all of the non-rectilinear touch surface.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 illustrates an example of a touch surface according to the prior art.

FIG. 2 illustrates an example of a non-rectilinear touch surface according to the prior art.

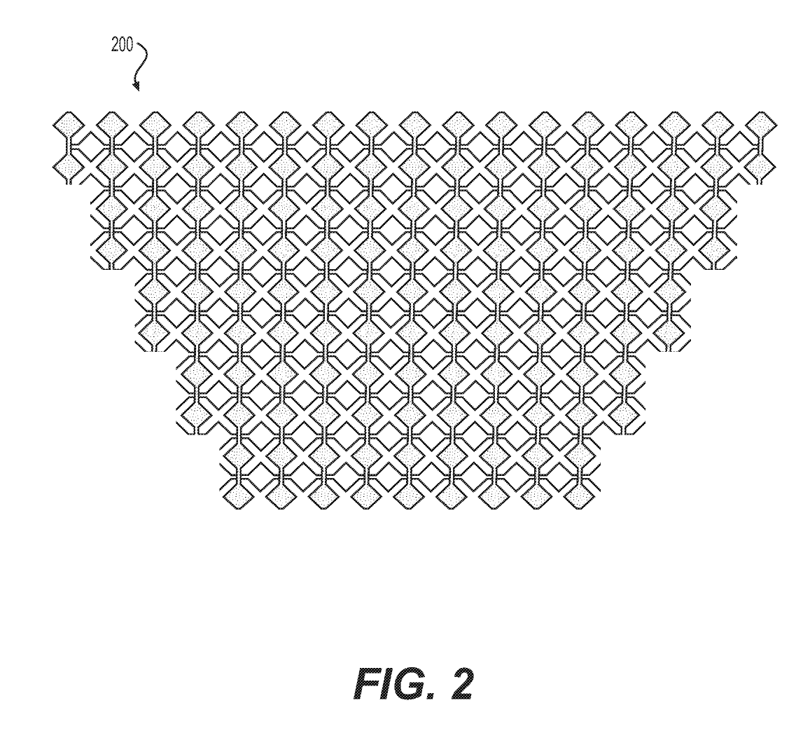

FIG. 3 illustrates a system level diagram for implementing a non-rectilinear touch surface according to the prior art.

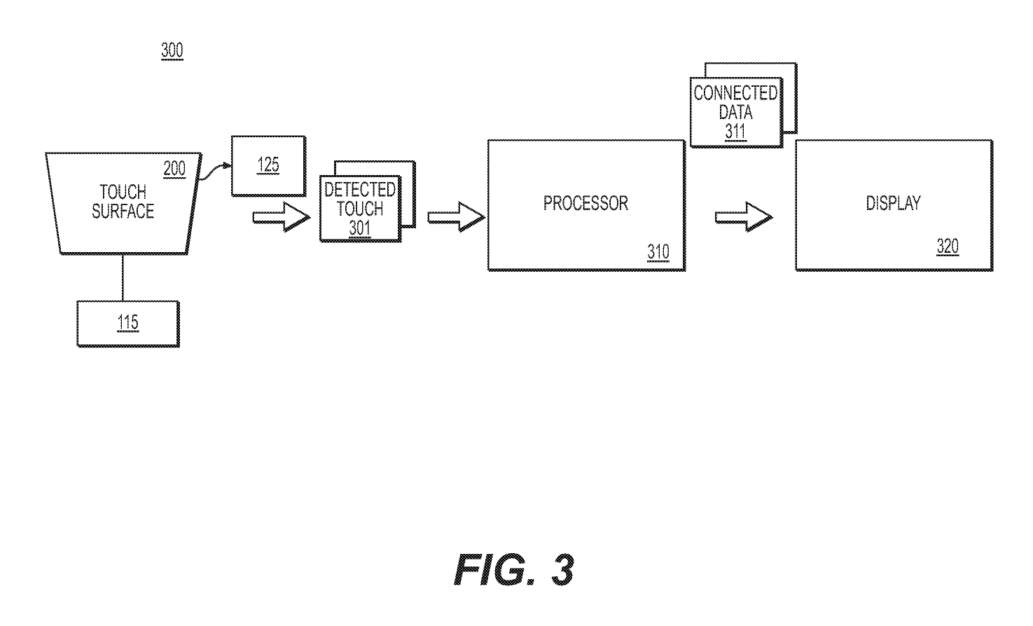

FIG. 4 illustrates an example of a plan-view of the touch surface.

FIG. 5 illustrates the cell of the touch surface of FIG. 4.

FIG. 6 illustrates a view of the bottom layer of FIG. 4.

FIG. 7 illustrates the views of FIG. 6.

FIG. 8 illustrates the bottom layer and top layer of FIG. 4.

FIG. 9 illustrates the various embodiments shown in FIG. 8.

### DETAILED DESCRIPTION

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X). Throughout the drawings and the detailed description, unless otherwise described, the same drawing reference numerals are understood to refer to the same elements, features, and structures. The relative size and depiction of these elements may be exaggerated for clarity, illustration, and convenience.

While lines are shown connected to the various components, any method/technique known may be implemented to communicate between the signals. For example, the signals may be communicated directly via wires, wirelessly, or through a centralized network router.

As explained in the Background section, there has recently been an increase in implementing touch surfaces (such as touch surface 100 and 200). These touch surfaces may be implemented in a variety of locations, such as vehicles, homes, and in any location where the detection of touch is employed to control or interact with an electronic system.

However, if a non-rectilinear touch surface 200 is implemented with a display (such as display 320) that is rectilinear or substantially rectilinear, the additional processing required to convert a non-rectilinear detected touch to a rectilinear display may be burdensome and delay the reaction time associated with replicating a touch via the display.

Disclosed herein are methods, systems, and devices for implementing and providing a non-rectilinear touch surface. Employing the aspects disclosed herein, an implementer or provider of a non-rectilinear touch surface may avoid the problems elaborated in the Background section of this disclosure.

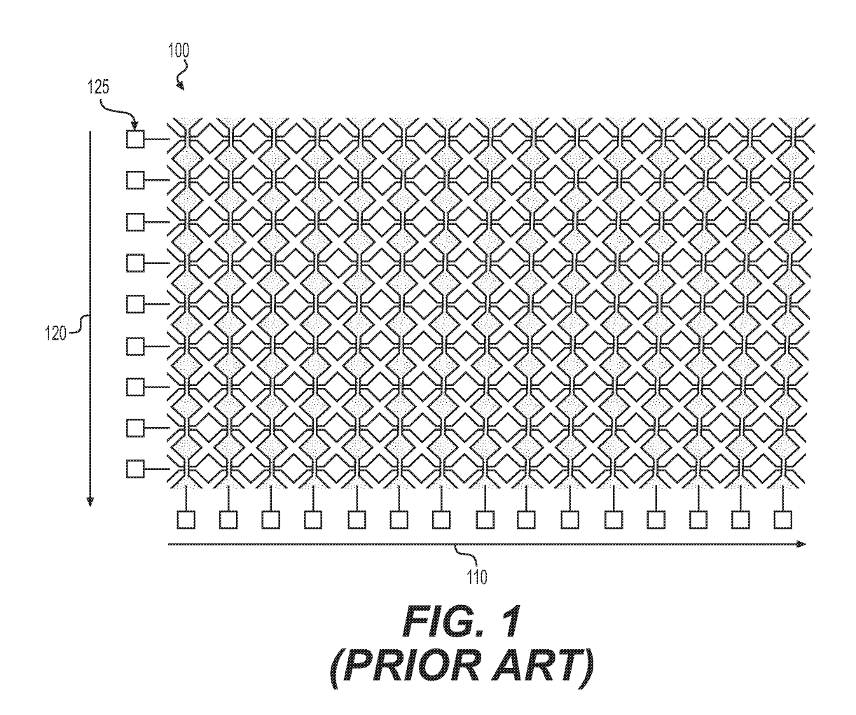

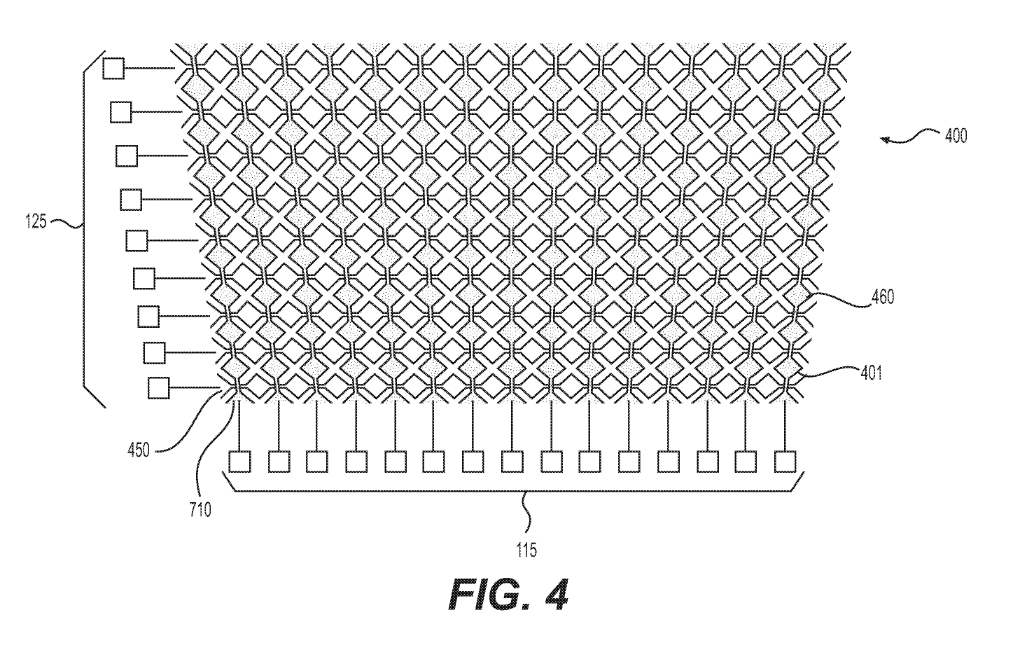

FIG. 4 illustrates an example of a plan-view of the touch surface 400 according to an exemplary embodiment. The touch surface 400 as shown operates with all the same peripheral circuits shown in FIG. 1 (i.e. sensors 115 on the x-axis, and scanning elements 125 on the y-axis). As shown in the Background, each of the sensors 115 and scanning elements 125 are provided for a respective y-axis line and x-axis line.

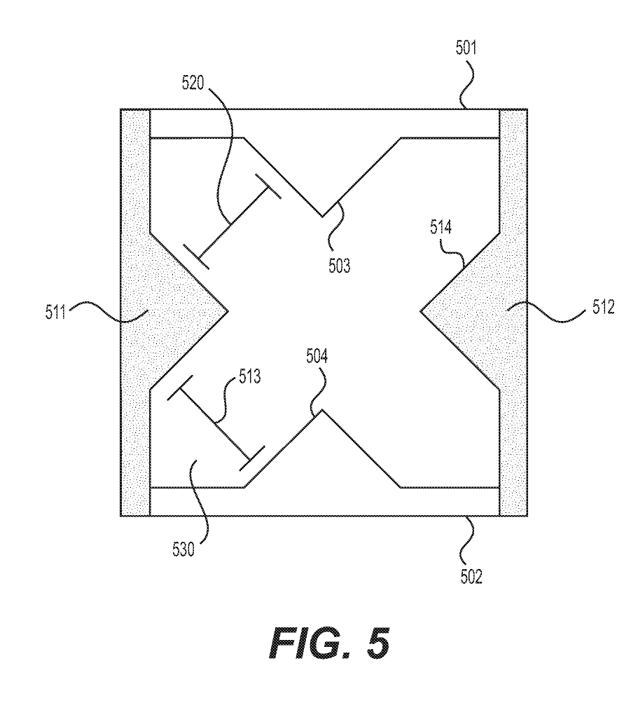

FIG. 4 also illustrates a variety of cells, with cell 401 exploded in FIG. 5 for exemplary purposes. FIG. 5 illustrates cell 401 of the touch surface 400, with various elements explained for illustrative purposes.

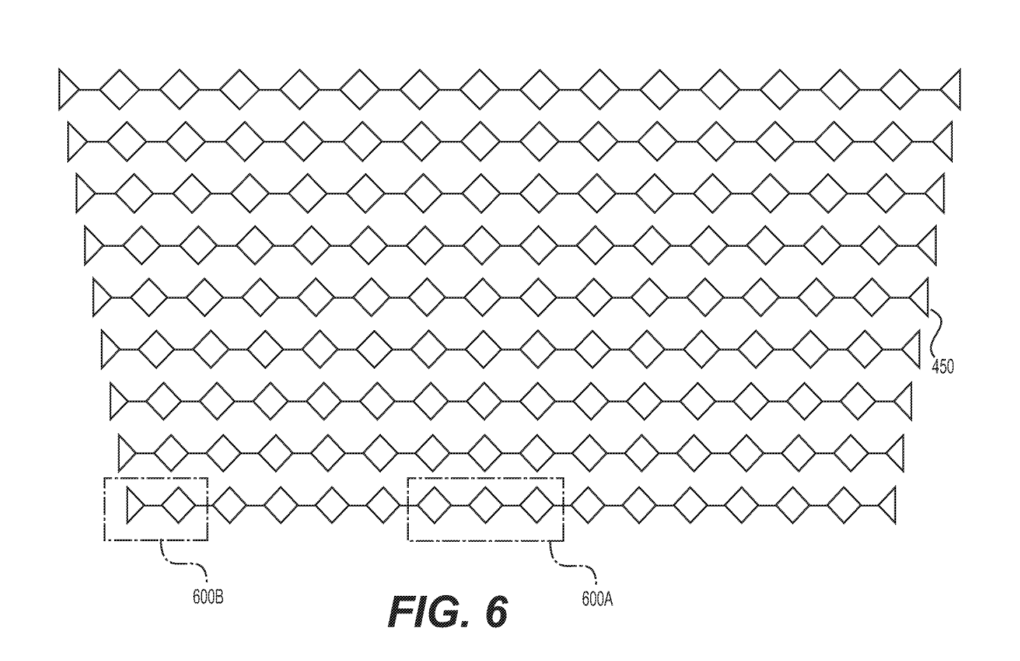

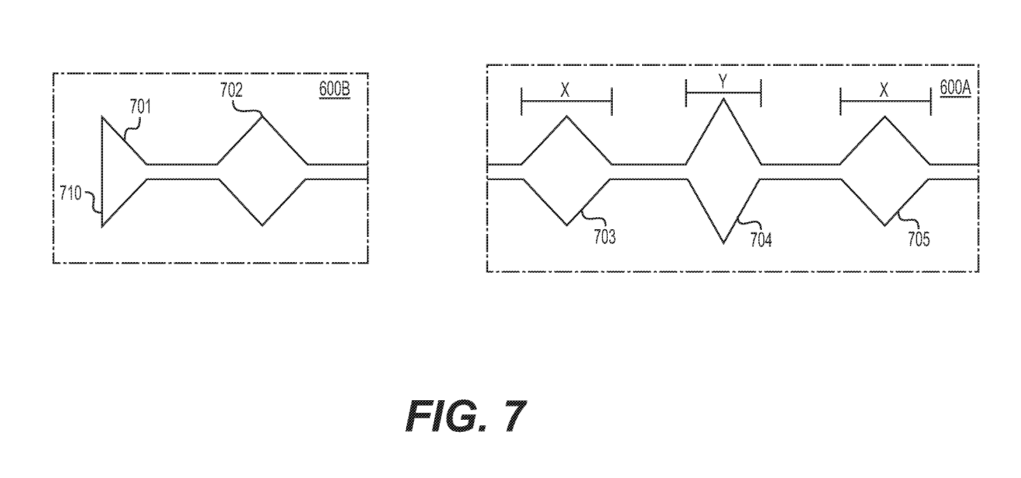

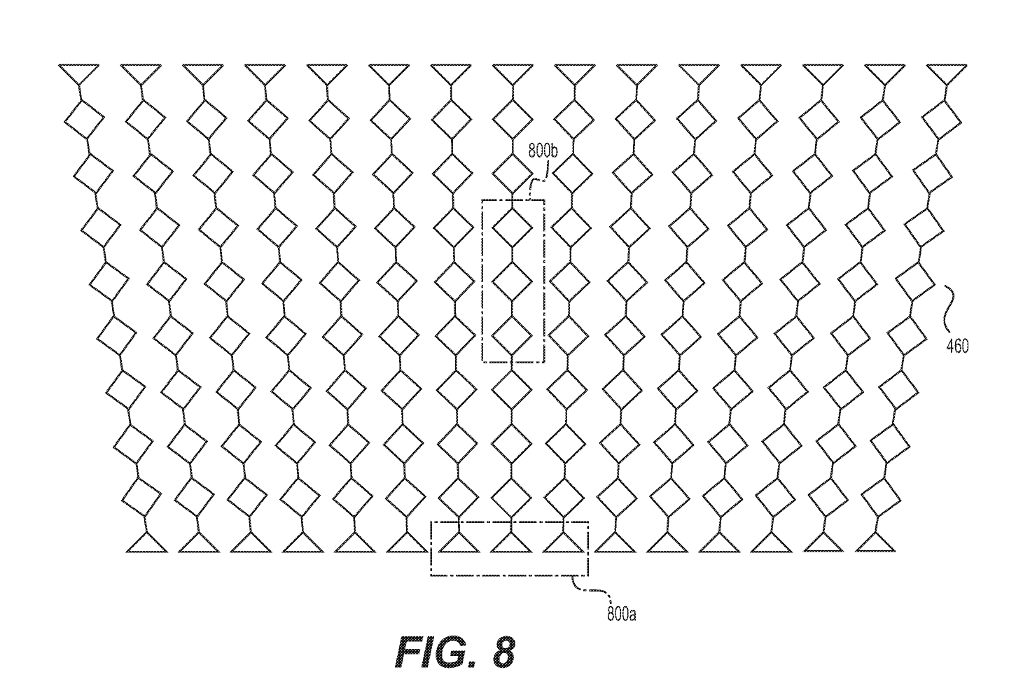

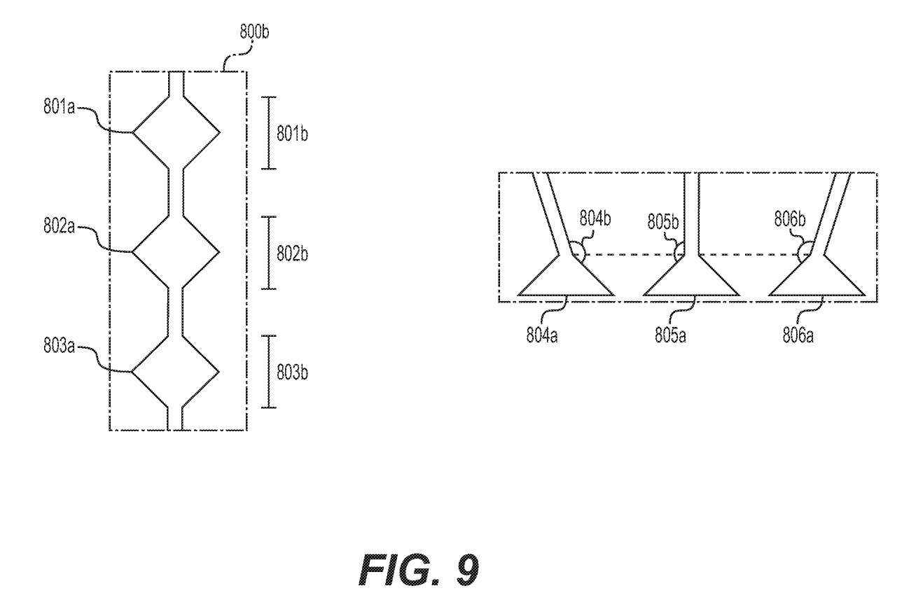

FIG. 4 includes two layers, a top layer 450 and a bottom layer 460. As explained in the Background section, touch surfaces have a scanning line and a sensing line. In the example shown herein, the top layer 450 (illustrated via FIGS. 6 and 7) and bottom layer 460 (illustrated via FIGS. 8 and 9) act as one of the plurality of scanning lines and sensing lines.

The touch surface 400 shown in FIG. 4 is in the shape of an inverted trapezoid (the aspects disclosed herein are not limited to the inverted orientation). However, because of the aspects shown and described below, the placement of the various x-axis and y-axis wires allows for there to be an equal number of cells for each horizontal row of cells.

As shown in FIG. 5, cell 501 is exploded and shown separated from touch surface 400′s other elements. In FIG. 5, y-axis wires are shown via wires 501 and 502. Each wire has a half diamond projection 503 and 504. Similarly, the x-axis wires are shown as 511 and 512, with corresponding projections 513 and 514.

While the projections are shown as being on both layers, in another example embodiment, the projections may all be on one of the bottom layer or top layer.

Also shown in FIG. 5 are gaps 520 and 530, which are formed by the various intersections of x-axis wires and y-axis wires. It should be appreciated that these gaps maintain a consistent spacing through the touch surface 400. As such, the various half diamond projections are sized accordingly to maintain said consistent gaps 520 and 530 throughout all of touch surface 400.

FIG. 6 illustrates a view of the bottom layer 450. As shown, the bottom layer 450 contains x-axis wires from a left-side of a touch surface 400 extending to a right-side of the touch surface 400. As explained above, these wires may be used for providing a scanning function or sensing function, depending on an implementer's preference.

As shown in FIG. 6, the bottom layer 450 is shaped in a trapezoidal fashion, as illustrated by the blown-up view 600b (shown in FIG. 7). Also shown in FIG. 6 is a blown-up view 600a which explains phenomena associated with the bottom layer 450.

As shown in FIG. 7, the views 600b and 600a each show a portion of the bottom layer 450, and specifically various portions of a single x-axis wire extending from the left to right side of the touch surface 400.

In 600b, two cells are provided, 701 and 702. As 701 is an edge cell, it is tapered to be a partial diamond with an angel 710. The angle 710 represents an angle defining the trapezoid shape of the touch surface 400.

In 600a, cells 703, 704, and 705 are shown. These cells correspond to the cell in the middle of the bottom layer 450 (running from a left side to a right side), and the corresponding cells on either side of the middle cell. As shown, the sizing of the diamonds is changed to maintain the consistent gap associated with gaps 520 and 530 shown in FIG. 5.

Complementary to the bottom layer 450, is the top layer 460, which is shown in greater detail in FIG. 8. The top layer 460 is also trapezoidal shaped in orientation and to illustrate the various embodiments shown, windows 800a and 800b, which are shown in greater detail in FIG. 9.

As shown in window 800a, end half projections 804a, 805a, and 806a are shown. These end projections each have a corresponding wire projecting from said end half projections, so that 804b, 805b, and 806b extend from a bottom side of the touch surface 400 to a top side of the touch surface 400. As shown, each of the wires form a respective angle with an x-axis line 810, 804c, 805c, and 806c. For illustrative purposes, the wire 805b was chosen as a middle wire, and as such, the angle 805c is substantially 90 degrees.

As such, in order to obtain the trapezoidal orientation, each wire to the left of the middle wire 805b forms an angle greater than 90 degrees, with the angle increasing the further to the left the wire is provided.

Conversely, the wires on the right side of the 805b are oriented in the opposite direction. As such, the corresponding angle decreases the further away a wire is provided from the middle wire 805b. As such, angle 806c is less than angle 805c.

Also shown is view 800b, which includes diamonds 801a, 802a, and 803a. These diamonds each have a respective size 801b, 802b, and 803b, with the respective sizes being chosen based on ensuring that the sizes of gaps 520 and 530 shown in FIG. 5 are maintained.

As such, constructing a touch surface 400 according to aspects shown in FIGS. 4-9 may provide a trapezoidal shape (or inverse trapezoidal shape), while maintaining an equal number of cells per row (i.e, intersections points between wires running from the x-axis to the y-axis). Accordingly, an implementer of the touch surface 400 may provide a direct interaction between the touch surface 400 and a display 320, without devoting additional processing power to covert said non-rectilinear touch points to a rectilinear output medium.

FIG. 10 illustrates a flow chart 1000 explaining a method of providing a non-rectilinear touch surface according to the aspects disclosed herein.

In operation 1010, wires extending from left to right (x-axis) are provided. In operation 1020, the wires are provided with the diamond projects shown in FIGS. 4-9. As explained, these projections are sized to maintain a constant gap throughout the whole touch surface 400. Also, the wires on the ends are provided with partial diamond cells to orient to the angled shaped of a trapezoid.

In operation 1030, wires extending from top to bottom (y-axis) are provided. In operation 1040, these wires are oriented so that the angle of the wires to the right and left of the middle wire vary in the manner shown in FIG. 8.

Similar to operation 1020, in operation 1050, the diamonds associated with the touch surface 400 are sized along the wires so as to maintain a constant gap formed by overlaying the top layer and the bottom layer.

If the proper angle of the wires are chosen, and the proper sizing of the various diamond cells provided on the vertical and horizontal wires, an implementer may be able to achieve a trapezoidal shape (or inverted trapezoidal shape) while maintain a constant number of cells per row.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

We claim:

1. A touch surface device, comprising:
a plurality of x-axis wires that extend from a left side to a right side, the right side opposing the left side;
a plurality of y-axis wires that extend from a top side to a bottom side, the bottom side opposing the top side, the plurality of y-axis wires and the plurality of x-axis wires being overlaid with each other;
wherein each of the plurality of x-axis wires are coupled to one of a plurality of signal generating elements or one of a plurality of sensing elements, and each of the plurality of y-axis wires are coupled to an opposite one of the plurality of signal generating elements or one of the plurality of sensing elements,
and each of the plurality of y-axis wires form a respective angle from a side that extend from the top to bottom side and a horizontal plane, and includes a middle wire that has a respective angle of 90 degrees, and each of plurality of the y-axis wires to a right of the middle wire's respective angle is greater than 90 degrees, and vary in an increasing amount, and each of the plurality of the y-axis wires to a left of the middle wire's respective angle less than 90 degrees, and vary in a decreasing amount.

2. The touch surface according to claim 1, wherein each of the plurality of x-axis wires and the plurality of y-axis wires include a plurality of diamond shaped projections.

3. The touch surface according to claim 2, wherein each of the plurality of diamond shaped projections are sized so a plurality of gaps that form in response to the plurality of x-axis wires and y-axis wires being overlaid with each are consistent in size.

4. The touch surface according to claim 2, further comprising partial diamond shape projects on ends of each of the plurality of x-axis wires.

5. The touch surface according to claim 1, wherein each of the plurality of respective angles are chosen so that the number of intersections points between the plurality of x-axis wires and y-axis wires are the same per row.

6. A method for providing a non-rectilinear touch surface, comprising:
providing a plurality of x-axis wires and y-axis wires overlaid with each other, each of the plurality of x-axis wires are coupled to one of a plurality of signal generating elements or one of a plurality of sensing elements, and each of the plurality of y-axis wires are coupled to an opposite one of the plurality of signal generating elements or one of the plurality of sensing element;
orienting the y-axis wires are extended from a top to bottom side of the non-rectilinear touch surface so as to form a trapezoidal shape;
providing a plurality of diamond projections on each of the plurality of x-axis wires and y-axis wires, so that in response to the plurality of x-axis wires and the plurality of y-axis wires being overlaid with each other, a constant gap between the plurality of diamond projections is maintained for all of the non-rectilinear touch surface.
